(19) United States
(12) Patent Application Publication
(10) Pub. No.: US 2022/0154973 A1
(43) Pub. Date: May 19, 2022

(54) Heating Device Having A Plurality Of Electrical Heating Elements

(71) Applicant: Vitesco Technologies GmbH, Hannover (DE)

(72) Inventors: Frank Baur, Munich (DE); Andreas Bernhardt, Munich (DE)

(21) Appl. No.: 17/428,366

(22) PCT Filed: Feb. 10, 2020
(86) PCT No.: PCT/EP2020/053303

§ 371 Date: Aug. 4, 2021

(30) Foreign Application Priority Data
Feb. 12, 2019 (DE) 10 2019 201 818.1

(51) Int. Cl. F24H 1/12; H05B 3/46; F24H 9/1818

(52) U.S. Cl. CPC F24H 1/121; H05B 3/46; H05B 2203/021; H05B 2203/013; H05B 2203/017; F24H 9/1818

(57) ABSTRACT

The embodiment relates to a heating device having a plurality of electrical heating elements (1; 1a, 1b, 1c, 1d) composed of a cylindrical hollow body (2), electrical heating resistors being formed on the jacket of said hollow body and connection ports (3a, 3b; 3a1, 3b1, 3a2, 3b2, 3a3, 3b3, 3a4, 3b4) for the inflow and outflow of a fluid being arranged on the end faces of said hollow body. The heating elements (1; 1a, 1b, 1c, 1d) are arranged parallel to one another. Each connection port (3a1, 3b1, 3a2, 3b2, 3a3, 3b3, 3a4, 3b4) of a heating element (1a, 1b, 1c, 1d) is connected to a connection port (3a1, 3b1, 3a2, 3b2, 3a3, 3b3, 3a4, 3b4) of another heating element (1a, 1b, 1c, 1d) in such a way that the heating elements (1a, 1b, 1c, 1d) are connected in series in respect of fluid throughflow with a first connection port as a total inflow connection port (3a1) and a second connection port as a total outflow connection port (3a4).

Electrical heaters for water-carrying tubular or hose-like lines are known. Thus there are, for example, water pipes in rooms that are not protected from the cold, in the case of which the actual pipeline is wrapped with resistance wires around which an insulation layer is usually fitted.

In addition, DE 20 2011 110 917 U1 discloses an electrically heatable fluid line for a vehicle.

However, these known electrical heaters for water-carrying tubular or hose-like lines usually have a considerable length of a few meters and are either assembled—for example as a garden hose—or produced for a special application.

The object of the invention is to find a cost-effective solution for electrical heaters for electric vehicles that can be easily assembled depending on the application or performance requirement.

The object is achieved by a heating device as claimed in claim 1. Advantageous developments are specified in the dependent claims.

Accordingly, a heating device according to the invention having a plurality of electrical heating elements is formed from a cylindrical hollow body, wherein electrical heating resistors are formed on the jacket of said hollow body and connection ports for the inflow and outflow of a fluid are arranged on the end faces of said hollow body. Here, the heating elements are arranged parallel to one another, wherein each connection port of a heating element is connected to a connection port of another heating element in such a way that the heating elements are connected in series in respect of fluid throughflow with a first connection port as a total inflow connection port and a second connection port as a total outflow connection port.

Therefore, in this way, heating elements of the same size and the same structure can be produced, these then being correspondingly spatially arranged in relation to one another depending on the desired performance requirement or the available installation space and the connection ports of said heating elements being connected to one another, so that a fluid to be heated can flow through them. As a result, a very compact structure can be achieved, which can nevertheless be produced from prefabricated elements depending on the application.

In a development of the heating device according to the invention, a drive circuit for the heating elements which is formed on a circuit carrier is provided, wherein the circuit carrier is arranged between the heating elements.

In an alternative to this, the circuit carrier with the drive circuit for the heating elements formed on it is arranged on an outer side of the heating device.

The invention is described in more detail below with reference to exemplary embodiments with the aid of figures, in which

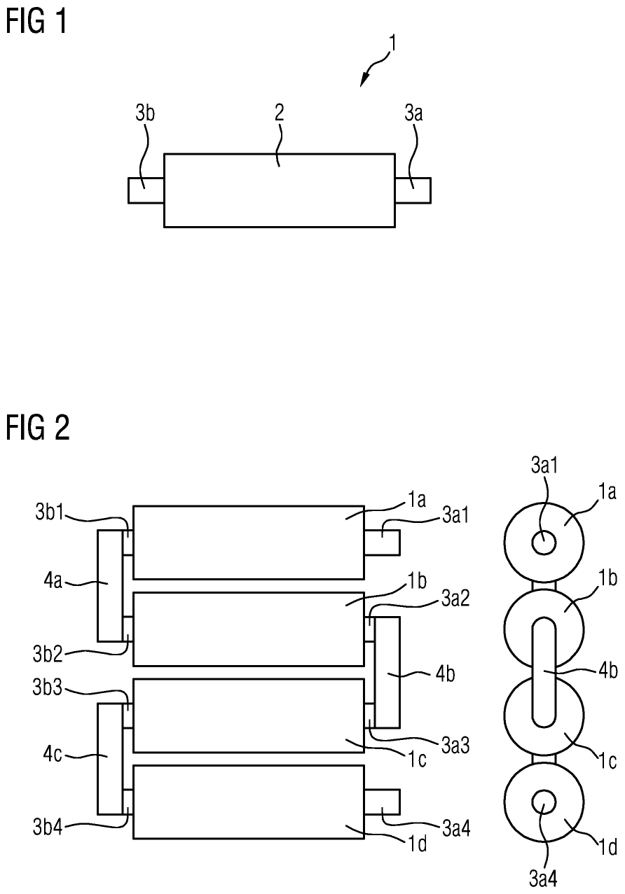

FIG. 1 shows a heating element for a heating device according to the invention,

FIG. 2 shows a heating device according to the invention having four heating elements which are arranged in one plane and connected in series in respect of a fluid throughflow,

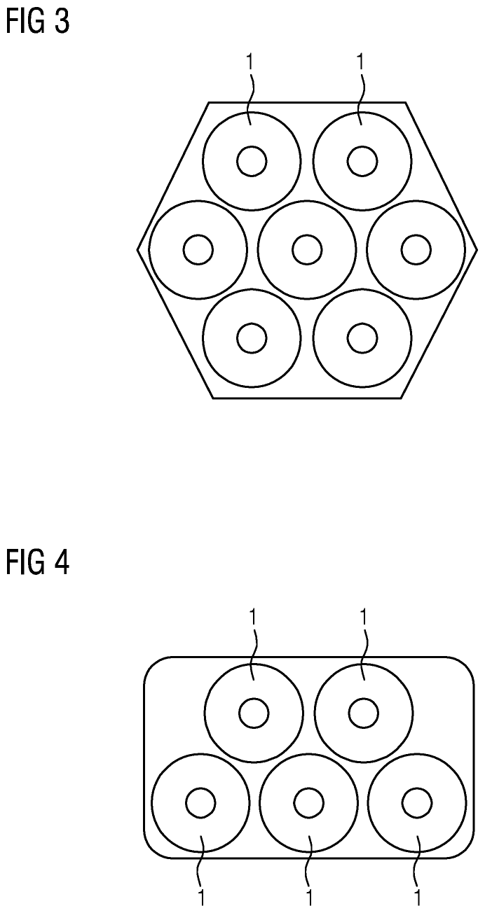

FIG. 3 shows a heating device according to the invention having seven heating elements which are arranged with a compact design,

FIG. 4 shows a further heating device according to the invention having five heating elements which are arranged with a compact design,

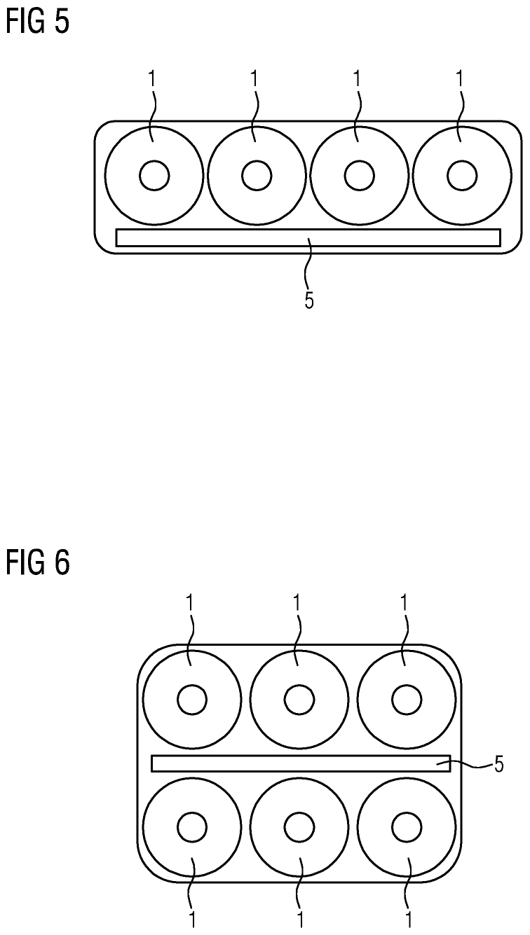

FIG. 5 shows a heating device according to the invention having four heating elements and a circuit carrier which is arranged on an outer side of the heating device, and

FIG. 6 shows a heating device according to the invention having six heating elements and a circuit carrier which is arranged between the heating elements.

A heating element 1 according to FIG. 1 is cylindrical and has a circular cross section, with other cross-sectional shapes also being possible. Heating resistors which can be produced in an advantageous and simple manner by cold gas spraying are formed on the jacket 2. The heating element 1 has two connection ports 3a, 3b which are formed on the end faces of the heating element 1 and serve for the inflow and outflow of a fluid—for example water.

FIG. 2 shows how heating elements 1a to 1d according to FIG. 1 can be combined in a manner according to the invention to form a heating device by way of a connection port 3b1 of a first heating element 1a being connected to a connection port 3b2 of a second heating element 1b via a first connecting line 4a and, in the same way, a connection port 3a2 of the second heating element 1b being connected to a connection port 3a3 of a third heating element 1c via a second connecting line 4b and a connection port 3b3 of the third heating element 1c being connected to a connection port 3b4 of a fourth heating element 1d via a third connecting line 4c. Here, a connection port 3a1 of the first heating element 1a forms a total inflow connection port and a connection port 3a4 of the fourth heating element 1d forms a total outflow connection port.

In the further illustrations of FIGS. 3 to 6, the heating elements 1 are intended to be connected to one another in the same way, but this is not shown. These illustrations show different arrangements of the heating elements in relation to one another, which arrangements are intended to illustrate the advantages of the heating device according to the invention composed of uniform heating elements. Therefore, depending on the required performance class, a corresponding number of heating elements 1 can be arranged in a compact manner in accordance with FIGS. 3, 4 and 6 or, depending on the spatial conditions, next to one another in accordance with FIG. 5. Here, a circuit carrier 5, on which a drive circuit—not shown—is formed, can also be arranged between the heating elements 1 in accordance with FIG. 6 or on the outer edge of the heating device in accordance with FIG. 5.

Here, the entire heating device can be installed in a housing 6, which is merely indicated in FIGS. 3 to 6.

A heating device according to the invention therefore has heating elements with a structure of tubular form which are scalable and can be arranged in any desired manner. Owing to the modular structure, heating devices for different performance classes are possible with always the same type of heating elements. The application of the heating resistors to the tube jacket is possible in a simple manner by, for example, cold gas spraying. Cost-effective production is possible owing to the modular structure.

Flow ducts for guiding fluid can be simply inserted into the tube of a heating element, this resulting in a flexible, simple and easy-to-seal structure.

1. A heating device comprising:
a plurality of electrical heating elements composed of a cylindrical hollow body,
electrical heating resistors formed on a jacket of said hollow body, and
connection ports for inflow and outflow of a fluid arranged on end faces of said hollow body,
wherein the plurality of heating elements are arranged parallel to one another,
wherein each connection port of a heating element is connected to a connection port of another heating element in such a way that the plurality of heating elements are connected in series in respect of fluid throughflow with a first connection port defining a total inflow connection port and a second connection port defining a total outflow connection port.

2. The heating device as claimed in claim 1, further comprising a circuit carrier configured to carry thereon a drive circuit for the heating elements, wherein the circuit carrier is arranged between the heating elements.

3. The heating device as claimed in claim 1, further comprising circuit carrier configured to carry thereon a drive circuit for the heating elements, wherein the circuit carrier is arranged on an outer side of the heating device.

4. The heating device as claimed in claim 1, wherein the electrical heating resistors are applied to the jacket by cold gas spraying.
